(19) United States
(12) Patent Application Publication
(10) Pub. No.: US 2019/0203838 A1
(43) Pub. Date: Jul. 4, 2019

(54) METHOD AND DEVICE FOR SEALING A JOINT GAP

(71) Applicant: RAANTEC GMBH & CO. KG, Borgholzhausen (DE)

(72) Inventors: Uwe HARTMANN, Horn Bad Meinberg (DE); Karl-Heinz PRÖSTLER, Guntersleben (DE); Ansgar JAHN, Hilter (DE)

(21) Appl. No.: 16/233,511

(22) Filed: Dec. 27, 2018

(30) Foreign Application Priority Data
Dec. 28, 2017 (DE) 10 2017 131 397.4

(51) Int. Cl. F16J 15/14; F16J 15/10

(52) U.S. Cl. CPC F16J 15/14; B05D 1/10; F16J 15/104; F16J 15/102

(57) ABSTRACT

A method for sealing a joint gap between mutually joined elements, at least one of which is a sheet, by applying a joint gap seal involves preheating an area of the joined elements to which the joint gap seal is to be applied. A polymer powder is introduced into a plasma jet to form a plasma and powder jet directed towards the preheated region of the elements. Polymer particles melted in the plasma and powder jet are deposited as joint gap seal.

### BACKGROUND AND SUMMARY OF THE INVENTION

Exemplary embodiments of the invention relate to a method and a device for sealing a joint gap between mutually joined elements, at least one of which is a sheet metal, by applying a joint gap seal.

Particularly in body construction in the automotive industry, there is a need to seal mutually joined elements, e.g., two joined sheets, in the joint area and thus to seal them. Doors, flaps or other car body elements with a cavity are usually made of two or more sheet metal elements formed in a stamping and embossing process. The sheet metal elements are usually laid one on top of the other so as to surround each other and are joined together along their overlap area. A joint connection can, for example, be made via a weld seam, via an arrangement of welding points or via an adhesive joint.

The joint area is often formed in the manner of a seam, i.e., the edges of two sheets do not lie on top of each other, but one of the sheets lies with its edge on the surface of the other sheet. The connection can also be formed as a double seam by turning over the underlying sheet metal. Depending on the type of joint, the sheets can be coated, e.g., galvanized or provided with a cathodic dip coating.

Normally, the joint gap created in the connecting area, i.e., in the joint area or seam area, is sealed, for example by applying a sealing material that is typically to be processed in a paste-like manner, for example on a PVC basis (polyvinyl chloride), to the seam area in the form of a bead. Usually the seam covers an edge area of the upper sheet by a few millimeters (mm) and projects just as far onto the surface of the underlying sheet.

Such a joint gap seal seals the two sheets in the transition area superficially, but is not able to penetrate into a gap between the sheets due to its consistency. As a result of ageing processes, e.g., thermal cyclic loading, mechanical stress (e.g., vibrations) or embrittlement, microcracks may form in the contact area between the sheet and the sealing material through which moisture penetrates and accumulates in the gap between the two sheets as a result of capillary action. The accumulated can lead to corrosion over time despite a possible coating of the sheets.

Exemplary embodiments are directed to a method and a device that creates a particularly corrosion-protective and durable joint gap seal.

A method for sealing a joint gap according to the invention comprises the following steps: An area of the joined elements, to which the joint gap seal is to be applied, is preheated. Further, polymer powder is introduced into a plasma jet to form a plasma and powder jet directed at the preheated area of the elements. Polymer particles melted in the plasma and powder jet are deposited as joint gap seal.

In accordance with the invention, a plasma jet is used to deposit polymer particles on the joined elements from which the joint gap seal is formed. The polymer powder introduced into the plasma jet assumes a dough-like consistency in the plasma jet, which leads to good adhesion of the applied polymer particles to the joined elements in the area of the joint gap. In connection with the preheating of the area to which the doughy polymer particles are applied, the energy input of the plasma beam in this area leads to a melting of the deposited polymer particles, which creates a melt bath or a melting bead during a feed between the plasma and polymer jets and the joined elements. In the melt bath or bead, the deposited polymer takes on a consistency that fills the joint gap. The result is a joint gap seal which penetrates into the joint gap and prevents corrosion of the joint gap from the inside.

Because the sealing part of the seal is located mainly in the joint gap, an effective sealing can be produced with little material. This leads to a significant saving in material and thus also in costs and weight compared to a sealing essentially arranged on the outside of the joint gap in accordance with the prior art. The method according to the invention is still compatible with commonly used automation and process sequences and can therefore be easily integrated into existing processes.

Non-thixotropic polymer powder, e.g., with a reactive polymer mixture, is preferably used. In particular, a lacquer powder is used as such a non-thixotropic polymer powder, for example a two-component lacquer powder. Non-thixotropic polymer in its temporarily liquefied form is “gap-moving”, i.e., its flow properties make it suitable for penetrating into the joint gap. However, precisely such non-thixotropic polymer materials in the form of applied pastes or the like are not or only very difficult to dose and process, as they pull threads, for example. However, in the method according to the invention in which the polymer powder is applied to the plasma jet, such non-thixotropic polymer powders can also be processed. Especially when two-component lacquer powder is used as polymer powder, the lacquer powder, which is also used in a subsequent lacquering of the joined elements, is preferred. This ensures a good compatibility of the joint gap seal and the subsequent lacquering and thus a good overcoating capability of the joint gap seal.

In an advantageous embodiment of the method, the polymer powder has an average particle size of 20-50 μm. In this particle size, the polymer powder can be well introduced into the plasma jet and assumes the desired doughy consistency in the jet. If necessary, foam additives can be added to make the joint gap seal flexible and not brittle.

In another advantageous embodiment of the method, the plasma jet is generated with a plasma nozzle that is operated with energy of less than about 1 kilowatt (kW). The plasma nozzle also preferably generates a plasma and powder jet with a diameter of less than 6 mm and preferably less than 4 mm in the preheated region of the joined elements. The mentioned energy range of the plasma nozzle leads to the desired heating of the polymer powder both within the plasma and powder jet as well as in the melt bath or melting bead which is formed on the joined elements.

In a further advantageous embodiment of the method, the preheating in the area in which the joint gap seal is applied is carried out to a temperature of approx. 80-150° C. It is preferably carried out locally (selectively), for example, with the aid of a laser beam or a focused light beam. Alternatively, inductive preheating is also possible, which can also be carried out locally and advantageously does not alter the surfaces of the elements.

In a further advantageous embodiment of the method, the plasma and powder jet strikes at an angle to a surface of at least one sheet metal. As a result of an inclined alignment of the plasma and powder jet, the resulting melt bath or the resulting melt bead can be specifically formed over the joint gap to be sealed at the edge of the at least one sheet so that an optimal penetration into the joint gap is provided.

In a further advantageous embodiment of the method, the applied joint gap seal is reheated. This can be done, for example, by a hot air flow, but also by inductive heating. It is also conceivable to carry out reheating in an oven, for example in the form of part of a subsequent lacquering process. The reheating hardens the resulting joint gap seal and thus adjusts the desired final toughness of the polymer used.

In a further advantageous embodiment of the method, it is carried out as a continuous process in which the joined elements move relative to the plasma nozzle. In this way a continuously sealing joint gap seal is created.

A device according to the invention for applying a joint gap seal for sealing joined elements, at least one of which is a sheet metal, has a preparation zone for heating a region of the joined elements and a treatment zone with a plasma nozzle and a powder supply for generating a plasma and powder jet. The device is set up to carry out the aforementioned method. The advantages mentioned in connection with the method will result.

### BRIEF DESCRIPTION OF THE DRAWING FIGURES

The invention will be explained in more detail below by reference to embodiment examples shown in the drawings, wherein:

FIG. 1 shows a schematic side view of a device for applying a joint gap seal;

FIG. 2 shows a schematic sectional view of an arrangement of second sheets with a joint gap seal according to the application; and

FIG. 3 shows a sectional view of FIG. 2 with a schematic indication of directions and sizes of different treatment and coating jets.

### DETAILED DESCRIPTION

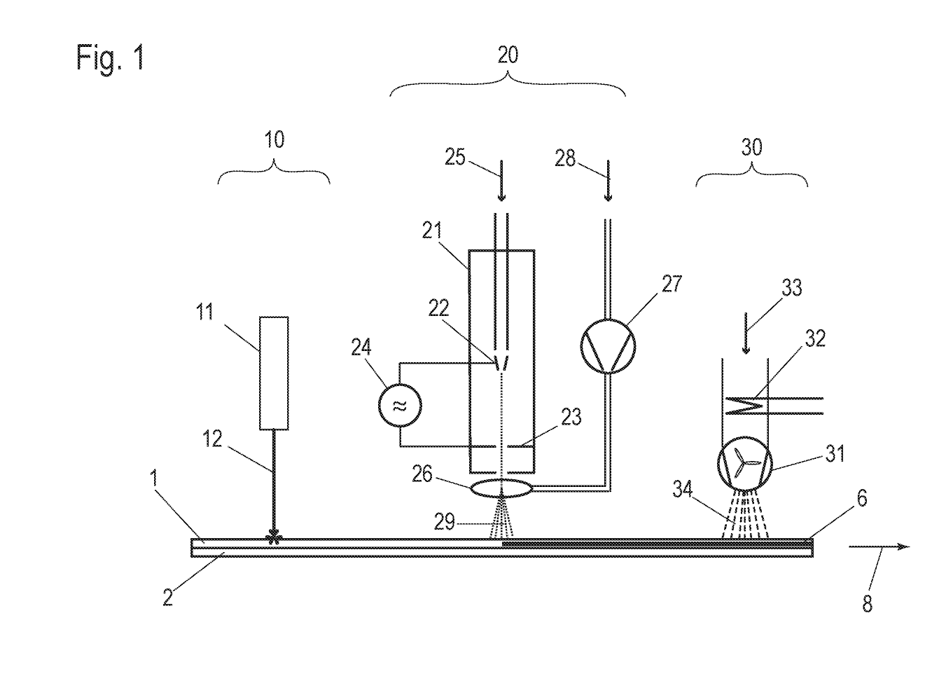

FIG. 1 schematically illustrates an exemplary embodiment of a device for applying a joint gap seal. The figure shows the device in a side view, wherein some elements are shown in sectional views to illustrate their internal structure.

The device processes a joined arrangement of at least two sheets lying on top of each other, a first sheet 1 and a second sheet 2 arranged on top of it. For this purpose, the arrangement of the two sheets 1, 2 moves relative to the device as indicated by a movement arrow 8. The movement arrow 8 indicates a feed direction of the arrangement of the two sheets 1, 2 relative to the device. In an alternative configuration, the device can be moved instead of the arrangement.

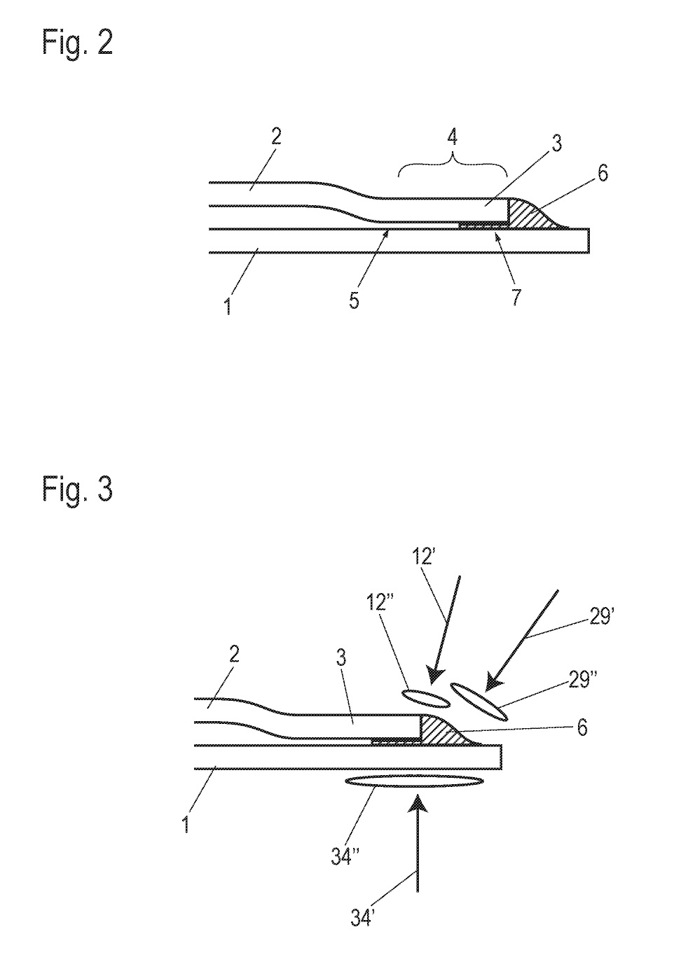

The arrangement of sheets 1, 2 processed by the device is illustrated in an example in a sectional drawing in FIG. 2. The section is executed in a plane perpendicular to the display plane of FIG. 1. It shows the first sheet 1, which is the lower one in FIG. 2, on which the second sheet 2, which in FIG. 2 is the upper one, is joined. One edge 3 of the second sheet lies on a surface of the first sheet 1, so that a fold is formed. The two sheets are joined together in an overlap area 4, in which they lie on top of each other, by the aforementioned joining, for example they are glued or welded together. One joining method frequently used particularly in the automotive industry is spot welding in overlap area 4. The occurrence of a joint gap 5 in the overlap area 4 is unavoidable—especially in an area between the spot-welded joints. Moisture penetrating into this joint gap 5 can lead to corrosion of the two sheets 1, 2, especially in the overlap area 4.

The central element of the device in FIG. 1 is a coating zone 20 in which material is applied to form a joint gap seal 6, hereinafter also referred to as seal 6.

The coating zone 20 comprises a plasma nozzle 21, which forms a plasma discharge between two electrodes, for example a cathode 22 and an anode 23 which is ring-shaped here. The plasma discharge is fed by an electrical generator 24, which is preferably designed as an alternating voltage generator, in particular as a high-frequency generator.

The plasma nozzle 21 is connected to a gas supply 25 through which, for example, nitrogen is supplied as plasma gas.

A plasma jet produced in the plasma nozzle 21 is fed powdery polymer material after its formation in a downstream powder nozzle 26, which is used to form the seal 6. The powder nozzle 26 is coupled to a powder pump 27 for this purpose, which in turn is connected to a powder feed 28. For example, the powder feed 28 can be fed from a storage vessel with the corresponding powder. Alternatively, the powder nozzle 26 can also be arranged inside the plasma nozzle 21. In this way a plasma and powder jet 29 is formed, which hits the elements to be joined, here the two sheets 1, 2.

The special features of the powder used as well as special parameters of the operation of the plasma nozzle 21 for applying the sealant are explained in more detail below.

A preparation zone 10 is provided upstream of coating zone 20 (seen in the feed direction of sheets 1, 2), in which local heating of sheets 1, 2 takes place in the area in which seal 6 is to be applied.

In the embodiment example shown, the preparation zone 10 has a laser 11 which heats the sheets 1, 2 locally with a laser beam 12. Suitable wavelengths of the laser beam 12 are, for example, in the range from 800 nanometers (nm) to 2500 nm. As an alternative to the laser beam 12, a focused light beam, in particular an infrared (IR) light beam generated by an IR light source, can also be used.

In addition, other methods can also be used for local heating of sheets 1, 2, for example inductive heating of sheets 1, 2. In this case, it is advantageous that the heated surfaces are not or only very slightly changed. Further alternatively, a (separate) plasma jet can also be used for preheating.

In addition, an aftertreatment zone 30 is optionally arranged downstream of the coating zone 20, in which a more extensive (compared with the preparation zone 10) heating of the sheets 1, 2 with the applied seal 6 is possible. In the embodiment example shown, the aftertreatment zone 30 comprises a fan 31 with an associated heater 32. The fan 31 and heater 32 convey or heat air supplied by an air supply 33 and thus generate a hot air flow 34 directed at the sheets 1, 2 and the seal 6. The material of the seal 6 is first gelatinized to suit and then cures. A seam collapse during curing is limited or prevented as far as possible by suitable gelatinization.

The installation shown in FIG. 1 is suitable for processing a two-dimensional structure. In principle, a three-dimensional contour of the joined elements can also be sealed if the joined elements are supplied and/or the system components (e.g. the plasma nozzle 21) can be moved accordingly.

Whereas joint gap seals according to the prior art usually use thixotropic pasty materials, a non-thixotropic polymer powder is used as the material for seal 6 in the case of a method according to the application and thus in the case of the device according to the application. Preferably, the powder is a lacquer powder, wherein the lacquer powder is used advantageously in that the sheets 1, 2 are lacquered in a later processing step (anyway). This ensures compatibility of the coating materials used. Adhesion problems or chemical incompatibilities between seal 6 and a subsequent lacquer application are safely avoided and a good overcoating capability of seal 6 is guaranteed. A foaming agent can be added to the lacquer powder to make the seal less brittle and more flexible.

Due to the special way in which the powder is applied and the preparation and treatment of the sheets 1, 2 during the application of the powder, a reliably sealing and long-lasting seal 6 is achieved even with a non-thixotropic (also called anti-thixotropic or rheopex) flow behavior of the powder.

In a method according to the application, the overlap area 4 of the sheets 1, 2 is preheated in the preparation zone 10 to a temperature between approx. 80° C. and 150° C., for example a temperature of approx. 100° C. The preheating takes place locally, preferably in the area of sheet edge 3 of the second sheet 2 in contact, for example at a point with a diameter of about 6 mm. By feeding the sheets 1, 2 a linear heated zone is formed accordingly.

The plasma and powder jet 29 is directed onto the thus preheated area in the coating zone 20. The plasma nozzle 21 is operated with energy of up to one kilowatt and a coating diameter of the plasma and powder jet 29 of about 2 to 4 mm is achieved. It should be noted that the radial distribution of the powder particles in the plasma and powder jet is not homogeneous but concentrated in the center. The plasma and powder jet 29 simultaneously further heats the already preheated area of sheets 1, 2 during the coating process, namely in an area whose diameter, for example, is 10 mm larger than the mentioned coating diameter of 2-4 mm.

In the plasma and powder jet 29, the powder particles are thermally melted by the temperatures prevailing there and assume a doughy consistency. The powder added preferably has particles with an average size of 20-50 μm. The particles are of a size of 20 to 50 μm in diameter.

The particles that have become doughy in the plasma jet already have a high initial application efficiency of 50% to over 80%, with which they adhere to the first sheet 1 or second sheet 2.

Due to the small diameter of the plasma and powder jet 29, an application can be carried out selectively in the area of the sheet edge 3 and the protruding surface of the first sheet 1. The heat input of the plasma and powder jet 29 gelatinizes the seal 6 already during the deposition process and is adjusted so that parts of the seal 6 penetrate in the form of a suitably long tongue 7 between the first and the second sheet metal 1, 2, supported by the capillary effect prevailing there. In addition, the application efficiency increases to almost 100%, as the powder particles are now deposited in already liquid material.

The result is a seal 6 as shown in the cross-section in FIG. 2: Good adhesion to the sheet edge 3 and the surface of the first sheet 1 in front of it and partial penetration into the joint gap 5 between sheets 1 and 2.

As indicated by the movement arrow in FIG. 1, seal 6 is preferably applied in a continuous process. At the start of the process, the plasma and powder jet 29 is first directed locally without feed to an area. The aforementioned powder particles that have become doughy are separated and further melted by the heat input of the plasma and powder jet. A molten polymer bath is formed. If this melt pool is large enough, the coating spot is moved along sheet edge 3 in a targeted manner so that the (round) melt pool becomes an elongated melting bead that moves along sheet edge 3. The formation of the melt pool or the melt bead can be adjusted by process parameters, in particular the setting of the energy of the plasma and powder jet, the temperature of the preheating and the feed speed.

The shape and size of the melting bead can also be monitored in one embodiment of the method, e.g., with the aid of automatically evaluated camera images, wherein the process parameters are adapted in such a way that a desired shape and/or size of the melting bead is maintained. In this way, deviations in the thickness of the sheets 1, 2 or the joint gap 5 and/or an increased material consumption of the polymer powder can be automatically compensated for by penetration of the joint gap 5 at different depths.

During coating, the molten state of the polymer transfers a large amount of heat to both sides of the joint gap 5. Due to the capillarity of the stacked sheets 1, 2 good gap filling is achieved. As a useful side effect of a targeted influence on the molten phase, many diffusion-controlled interactions with the surfaces and thus a defined structure of an adhesion bond are also achieved.

As a result of the optional heat aftertreatment in the aftertreatment zone 30, a targeted flow and melting of powder particles in the seal 6 can take place. The heat input in the aftertreatment zone terminates the gelatinization and the polymer of the seal 6 hardens and obtains its final properties, for example its toughness.

It is noted that sheets 1, 2 including seal 6 are usually lacquered after application of seal 6, wherein the lacquering process comprises the curing of the lacquer in an oven. The curing of the lacquer in the oven can represent the above-mentioned optional heating aftertreatment.

Apart from the formation of a well-adhering seal 6, the described method results in virtually no “overspray”, i.e., no or very little material is deposited outside the desired area on sheets 1, 2, which means that a subsequent cleaning step to remove this excess material can be dispensed with. Aftertreatment in the aftertreatment zone 30 is preferably carried out at temperatures of about 120° C.

The described process can be run through two or more times in order to achieve an even deeper penetration of the sealing tongue 7 into the joint gap 5. Furthermore, a multiple repetition of the process offers the possibility to specifically build up and/or influence the part of the seal 6 outside the joint gap 5 in its three-dimensional form.

FIG. 3 shows the diagram of FIG. 2 again with exemplary directions 12′, 29′, 34′ of the different coating and treatment jets or flows and the resulting effective range 12″, 29″, 34″.

In this case, the direction 12′ and the effective area 12″ refer to the preheating, e.g., by the laser beam 12 or a corresponding focused light beam or also by inductive preheating. The effective area 12″ indicates approximately the size and positioning of the preheated area of the joined elements.

The direction 29″ refers to the plasma and powder jet 29. The effective area 29″ indicates approximately the size and positioning of the area in which the powder particles that have become doughy impinge. A direction 29′ is advantageously set, in which the plasma and powder jet 29 strikes the joint gap 5 to be filled and the sheet edge 3 at an angle.

Direction 34′ relates to the hot air flow 34 for reheating. The effective area 34″ indicates approximately the size and positioning of the reheated area. In the example shown in FIG. 3 (other than shown in FIG. 1), the reheating takes place from the side opposite the seal (rear side). It can clearly be seen that the reheating takes place in a broader section than the more local preheating. It should be noted that preheating can also be carried out from the rear side.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE NUMERALS

1 First sheet
2 Second sheet
3 Sheet edge
4 Overlap area
5 Joint gap
6 Joint gap seal
7 Tongue
8 Movement arrow
10 Preparation zone
11 Laser
12 Laser beam
20 Coating zone
21 Plasma nozzle
22 Cathode
23 Anode
24 Generator
25 Gas supply
26 Powder nozzle
27 Powder pump
28 Powder supply
29 Plasma and powder jet
30 Aftertreatment zone
31 Fan
32 Heating
33 Air supply
34 Hot air flow
12′, 29′, 34′ Direction
12″, 29″, 34″ Effective range

1. A method for sealing a joint gap between mutually joined elements, at least one of which is a sheet, the method comprising:
preheating an area of the mutually joined elements to which a joint gap seal is to be applied;
introducing polymer powder into a plasma jet to form a plasma and powder jet directed towards the preheated area of the mutually joined elements;
depositing polymer particles melted in the plasma and powder jet as the joint gap seal.

2. The method of claim 1, wherein two sheets are joined together as elements.

3. The method of claim 1, wherein the polymer powder is a non-thixotropic polymer powder.

4. The method of claim 3, wherein the non-thixotropic polymer powder is a lacquer powder.

5. The method of claim 4, wherein the lacquer powder contains foaming additives.

6. The method of claim 1, wherein the polymer powder has an average particle size of 20-50 μm.

7. The method of claim 1, wherein the plasma jet is generated with a plasma nozzle operated at energy of less than about 1 kW.

8. The method of claim 1, wherein the plasma and powder jet in the preheated region of the joined elements has a diameter of less than 6 mm.

9. The method of claim 1, wherein the mutually joined elements are preheated to a temperature of 80° C. to 150° C. in the area of the mutually joined elements to which the joint gap seal is applied.

10. The method of claim 8, wherein the preheating is carried out locally.

11. The method of claim 9, wherein the preheating is performed using a laser beam or a focused light beam.

12. The method of claim 9, wherein preheating is performed inductively.

13. The method of claim 1, wherein the plasma and powder jet impinges obliquely on a surface of the sheet.

14. The method of claim 1, further comprising:
reheating the applied joint gap seal.

15. The method of claim 14, wherein a hot air flow is used for reheating.

16. The method of claim 14, wherein reheating occurs in a furnace.

17. The method of claim 16, wherein reheating in the furnace is part of a lacquering process.

18. The method of claim 1, wherein the method is performed as a continuous process in which the mutually joined sheets move relative to a plasma nozzle that generates the plasma jet.

19. A device for applying a joint gap seal for sealing mutually joined elements, at least one of which is a sheet, the device comprising:
a preparation zone configured to heat an area of the mutually joined elements; and
a treatment zone, having a plasma nozzle and a powder supply, configured to generate a plasma and powder jet by introducing polymer powder into a plasma jet to form a plasma and powder jet directed towards the preheated area of the mutually joined elements and depositing polymer particles melted in the plasma and powder jet as the joint gap seal.
